(19) United States
(12) Patent Application Publication
(10) Pub. No.: US 2026/0228965 A1
(43) Pub. Date: Aug. 6, 2026

(54) SCALABLE PROCESSOR DESIGN

(71) Applicant: QUALCOMM Incorporated, San Diego, CA (US)

(72) Inventors: Ashokanand NEELAMBARAN, San Diego, CA (US); Jian LIANG, San Diego, CA (US); Zhenbiao MA, Saratoga, CA (US); Himakiran AREPALLI, Bangalore (IN); Antonio FLORES, Escondido, CA (US); Nithin GOPALAKRISHNA, San Diego, CA (US)

(21) Appl. No.: 19/042,893

(22) Filed: Jan. 31, 2025

(51) Int. Cl. G06T 15/80; G06T 1/20

(52) U.S. Cl. CPC G06T 15/80; G06T 1/20

(57) ABSTRACT

This disclosure provides systems, devices, apparatus, and methods, including computer programs encoded on storage media, for improving scalable GPU design. A graphics processor may obtain, from a register of the graphics processor, a slice mask for a set of slices available to the graphics processor. The graphics processor may distribute a set of vertex shading tasks to the set of slices based on the obtained slice mask. The graphics processor may distribute a set of pixel shading tasks to the set of slices based on the obtained slice mask.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques may not address easy scalability of multi-core processor design. There is a need for improved multi-core processor design techniques.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus a memory; and at least one processor coupled to the memory and, based at least in part on information stored in the memory, the at least one processor may be configured to obtain, from a register of a graphics processor, a slice mask for a set of slices available to the graphics processor. The at least one processor may be configured to distribute a set of vertex shading tasks to the set of slices based on the obtained slice mask. The at least one processor may be configured to distribute a set of pixel shading tasks to the set of slices based on the obtained slice mask.

In some aspects, the techniques described herein relate to a method of graphics processing, including: obtaining, from a register of a graphics processor, a slice mask for a set of slices available to the graphics processor; distributing a set of vertex shading tasks to the set of slices based on the obtained slice mask; and distributing a set of pixel shading tasks to the set of slices based on the obtained slice mask.

In some aspects, the techniques described herein relate to a method, further including: executing, via the set of slices, the set of vertex shading tasks based on the distribution of the set of vertex shading tasks; and executing, via the set of slices, the set of pixel shading tasks based on the distribution of the set of pixel shading tasks.

In some aspects, the techniques described herein relate to a method, where each of the set of slices includes a graphics processor unit (GPU) sub-core having a vertex shading pipeline and a pixel shading pipeline, where distributing the set of vertex shading tasks to the set of slices based on the obtained slice mask includes: distributing the set of vertex shading tasks to at least one corresponding vertex shading pipeline of the set of slices, where distributing the set of pixel shading tasks to the set of slices based on the obtained slice mask includes: distributing the set of pixel shading tasks to at least one corresponding pixel shading pipeline of the set of slices.

In some aspects, the techniques described herein relate to a method, further including: determining a number of active slices of the set of slices based on the obtained slice mask.

In some aspects, the techniques described herein relate to a method, further including: obtaining, from a second register of the graphics processor, an indication of a number of active slices of the set of slices available to the graphics processor.

In some aspects, the techniques described herein relate to a method, where distributing the set of pixel shading tasks to the set of slices based on the obtained slice mask includes: selecting a hashtag pattern from a plurality of hashtag patterns based on a number of active slices of the set of slices available to the graphics processor; and distributing the set of pixel shading tasks to the set of slices based on the selected hashtag pattern and the slice mask.

In some aspects, the techniques described herein relate to a method, further including: obtaining, from a second register of the graphics processor, an indication of the plurality of hashtag patterns before the selection of the hashtag pattern from the plurality of hashtag patterns.

In some aspects, the techniques described herein relate to a method, where obtaining, from the register of the graphics processor, the indication of the slice mask for the set of slices available to the graphics processor includes: reading the indication from the register of the graphics processor during a power-up process of the graphics processor.

In some aspects, the techniques described herein relate to a method, further including: receiving the indication of the slice mask from a user interface; and storing the indication of the slice mask to the register of the graphics processor before obtaining, from the register of the graphics processor, the indication of the slice mask.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system, in accordance with one or more techniques of this disclosure.

FIG. 2 illustrates an example GPU in accordance with one or more techniques of this disclosure.

FIG. 3 illustrates an example image or surface in accordance with one or more techniques of this disclosure.

FIG. 4A illustrates a scalable GPU having four slices, in accordance with one or more techniques of this disclosure.

FIG. 4B illustrates a scalable GPU having two slices, in accordance with one or more techniques of this disclosure.

FIGS. 5A-5D illustrate hashtag patterns for scalable GPUs having various numbers of slices, in accordance with one or more techniques of this disclosure.

FIG. 6 is a call flow diagram illustrating example communications between a core of a GPU and a set of slices of the GPU, in accordance with one or more techniques of this disclosure.

FIG. 7 is a flowchart of an example method of graphics processing, in accordance with one or more techniques of this disclosure.

FIG. 8 is a flowchart of an example method of graphics processing, in accordance with one or more techniques of this disclosure.

FIG. 9 is a flowchart of an example method of graphics processing, in accordance with one or more techniques of this disclosure.

FIG. 10 is a flowchart of an example method of graphics processing, in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

The following description is directed to examples for the purposes of describing innovative aspects of this disclosure. However, a person having ordinary skill in the art may recognize that the teachings herein may be applied in a multitude of ways. Some or all of the described examples may be implemented in any device or system that is capable of processing graphics commands. Various aspects relate generally to reprojecting and/or composing frames for a graphics processing unit (GPU). Some aspects more specifically relate to applying reprojection fallback strategies during an excess system load (e.g., when a reprojection process for a frame will not complete in time to display the frame). For example, a graphics system may have limited dynamic random access memory (DRAM) bandwidth due to concurrent work (e.g., rendering, GPU workload, high-intensity periods of camera data acquisition), software control latencies (e.g., poorly optimized code, latencies when communicating with third-party applications), bottlenecking hardware execution, and/or power/thermal throttling. Such loads may affect the calculated projected time for a reprojection process to complete within a threshold period of time. Use of remotely-rendered framebuffers (e.g., frames processed by a reprojection topology on a separate system, or a third-party system), may also affect the time to render a frame. For example, use of a second reprojection process may conserve resources if a first reprojection process uses remote-rendered framebuffers having a high calculated latency value, or if a first reprojection process uses a large amount of bandwidth (e.g., WiFi, 5G bandwidth) and a system is configured to conserve use of that bandwidth with respect to transmission/reception of remote-rendered frames.

In some aspects, a GPU may have a scalable GPU architecture using a chop structure. A chop GPU structure may be a scalable architecture which allows a common chip core to connect to different numbers (e.g., one, two, three, or four) of sub-core fungible slices. The slices of a chop GPU may be chopped into portions in the power delivery (PD) of the GPU. Connecting more slices to a common chip core will increase the performance of the GPU. To create a lower performance GPU, unwanted slices may be physically “chopped” off of the GPU. The connections (e.g., the output of the removed slices) to the chopped off slices may be physically tied off. For example, the port level endpoints of a removed slice may be statically tied-off using an engineering change order (ECO). In some aspects, a sliced GPU may have a hardwired configuration to support distribution of the workloads into a fixed number of slices. Such a hardwired configuration may allow a sliced GPU to concurrently use as many slices as possible for maximum performance but utilizes the sliced GPU to be hardwired by an administration user. In some aspects, a hardware dynamic workload distribution system may support any arbitrary number of active slices connected to the common chip core of the sliced GPU. Removal of the active slices may be transparent to the workload distributer (e.g., unslice) and the other slices, for example the endpoints may be tied off using an ECO. For vertex workloads, the GPU may distribute vertex tasks based on the number of active slices, which may be a run-time programmable parameter or a configuration register. An active slice may be a slice that is powered by the GPU, or is otherwise functional. An inactive slice may be a portion of a chop GPU that may be coupled to an active slice, but is not connected to a slice of a chop GPU, or is otherwise powered by a PD of the chop GPU. In other words, the connections to the inactive slice may be tied off, and the inactive slice may not be present on the chop GPU. For fragment/pixel workloads, the GPU may distribute pixel tasks based on one of a plurality of flavors of hashing functions—one for each possible number of slices. For example, if the scalable GPU has a maximum of four slices, the GPU may have four different built-in hashtag functions, one for each configuration of one, two, three, or four slices.

In some examples, a graphics processor (or graphics processor system) may obtain, from a register of a graphics processor, an indication of a slice mask for a set of slices available to the graphics processor. A slice mask may indicate which slice connectors are connected to an active slice, and which slice connectors are not connected to an active slice. An indication of a slice mask may be any data that refers to a slice mask, for example a bit representation of a slice mask (e.g., 1110 to indicate the first three slices of a 4-chop GPU active and the last slice of the 4-chop GPU not active), or an index to a slice mask (e.g., 10 to indicate a third mask of a choice of four masks for a 4-chop GPU). The graphics processor may distribute a set of vertex shading tasks to the set of slices based on the obtained slice mask. A vertex shading task may include a workload to shade a set of vertices. The graphics processor may distribute a set of pixel shading tasks to the set of slices based on the obtained slice mask. A pixel shading task may include a workload to shade a set of pixels. The graphics processor may use the slice mask to adapt, or reconfigure itself, to seamlessly execute a GPU application to make use of the active number of active slices without trying to access inactive slices, or allocating resources to access points to inactive slices.

Particular aspects of the subject matter described in this disclosure can be implemented to realize one or more of the following potential advantages. In some examples, by configuring a GPU to have a dynamic reconfiguration of slice architecture, the described techniques can be used to rapidly scale up or down a scalable GPU without using a hardwired configuration. This reduces the design, design verification (DV), and/or power delivery (PD) non-recurring engineering (NRE) costs for scaling up or down the number of slices attached to a GPU.

The examples described herein may refer to use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

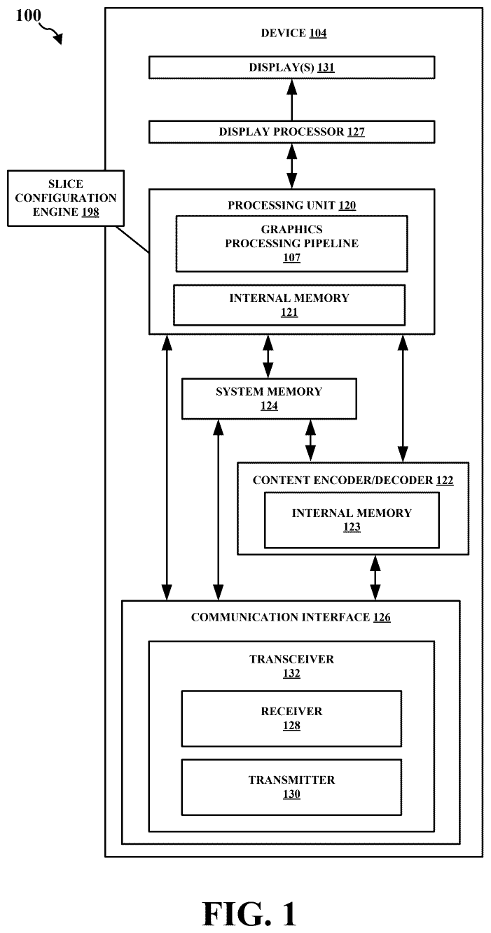

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a slice configuration engine 198 configured to obtain, from a register of a graphics processor, a slice mask for a set of slices available to the graphics processor. The slice configuration engine 198 may be configured to distribute a set of vertex shading tasks to the set of slices based on the obtained slice mask. The slice configuration engine 198 may be configured to distribute a set of pixel shading tasks to the set of slices based on the obtained slice mask. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

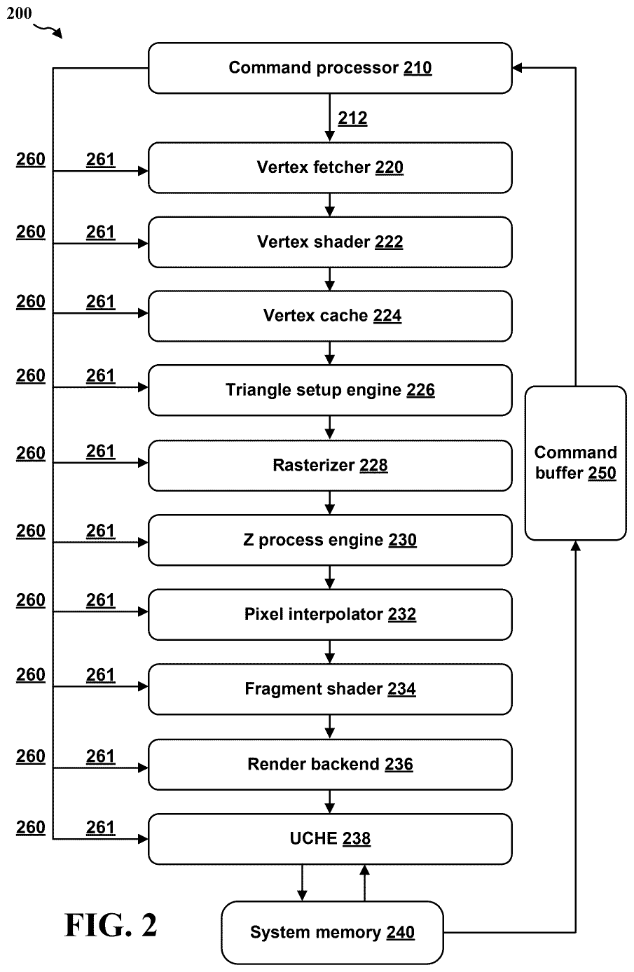

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

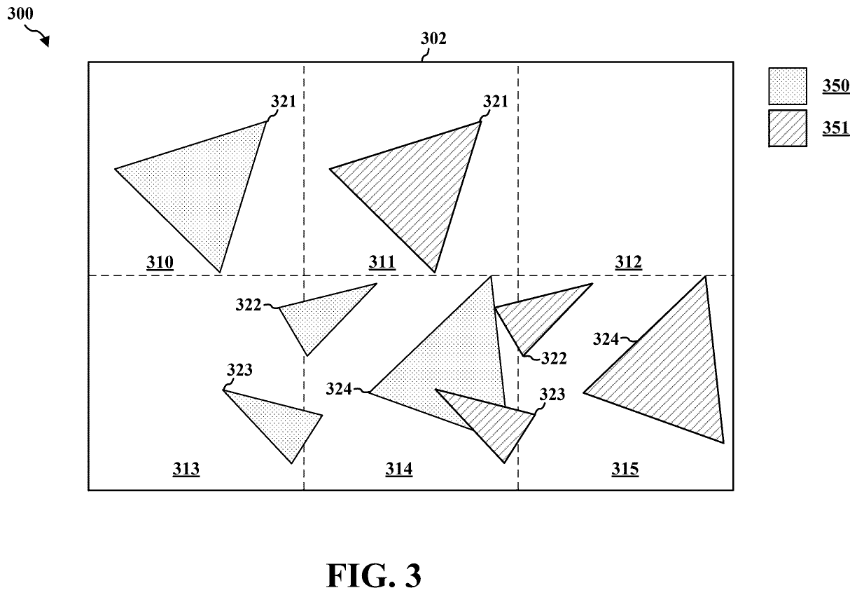

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

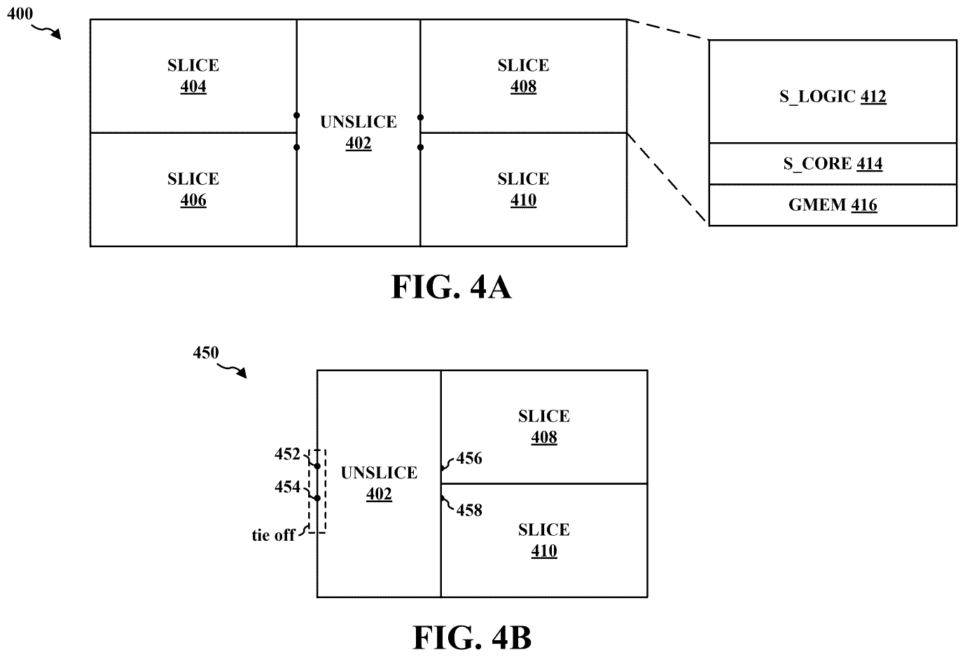

FIG. 4A is a diagram 400 of a scalable GPU having an unslice 402, a slice 404, a slice 406, a slice 408, and a slice 410. The unslice 402 may be a set of non-collapsible logic that controls the logic of the scalable GPU, which acts as the central workload distributor/reassemble of the scalable GPU. The unslice 402 may have, for example, a core processor, a set of sub-core processors, memory, and a set of programmable logic that can be used to scale the number of slices used by the scalable GPU up or down. Each of the slice 404, the slice 406, the slice 408, and the slice 410 may be fungible slices connected to the logic of the unslice 402 by a set of connections, shown here as connection 452 for the connection between the slice 404 and the unslice 402, connection 454 for the connection between the slice 406 and the unslice 402, connection 456 for the connection between the slice 408 and the unslice 402, and connection 458 for the connection between the slice 410 and the unslice 402. Each slice may have, for example, a slice core 414, a graphics memory (GMEM) 416, and a set of slice logic modules 412. Each slice may fundamentally be a collective unit of GPU processing engine modules, which may house a fixed size traditional geometry, pixel processing fixed function components, and shader processing entities. The geometry-pipe fixed function components may include a primitive assembly, tessellation, and triangle setup, whereas the pixel-pipe fixed function components may include rasterization, depth-check, and format conversion.

The scalable GPU shown in FIG. 4A may include the maximum number of slices capable of being connected with the unslice 402, in this case four slices. In some aspects, scalable GPUs may be configured to have a maximum or more or less slices. In some aspects, the scalable GPU may be manufactured with less slices, for example three slices, two slices, or one slice. Providing such a scalable GPU may enhance the scalability of a GPU having multiple slices to facilitate the production of lower stock keeping units (SKUs) of a parent GPU with minimal, or no non-recurring engineering (NRE) costs. In other words, a premium tier chip may be manufactured with the maximum number of slices that can be coupled to an unslice, and a slew of lower tier derivative chips may be manufactured with less slices, which are scaled down versions of the parent GPU with the same unslice but less slices coupled to the unslice. This enables a user to generate multiple flavors of the premium GPU with minimal NRE costs.

FIG. 4B is a diagram 450 of the scalable GPU of FIG. 4A having two less slices, with the slice 404 and the slice 406 removed. A user may tie off the connection 452 and the connection 454 using ECO at the port level endpoints of the removed slices. In other words, a user may physically remove any number of slices from the GPU core of the die and physically tie off the output of the removed slices to enable the rest of the GPU to work. This makes removal of the slices totally transparent to the unslice 402 and the slice 408 and the slice 410.

In some aspects, the unslice 402 may have a hardwired configuration that utilizes all of the connected slices at once to provide the maximum performance. In other words, the unslice 402 in FIG. 4A may have a hardwired configuration to use each of the slice 404, the slice 406, the slice 408, and the slice 410 simultaneously, while the unslice 402 in FIG. 4B may have a hardwired configuration to use each of the slice 408 and the slice 410 simultaneously. However, providing such hardwired configurations may be realized by separately manufacturing the unslice 402 in FIG. 4A and the unslice 402 in FIG. 4B in different ways.

In other aspects, the unslice 402 may be configured to support any number of active slices connected to the unslice 402 using a programmable memory. In other words, the unslice 402 in FIG. 4A may function with one, two, three, or four slices without any hardwired configuration that limits the number of slices that can be removed from the unslice 402.

When the unslice 402 renders the workload to be performed by the connected slices, the unslice 402 may distribute vertex shading tasks and pixel shading tasks. When the unslice 402 distributes vertex shading tasks to the connected slices, the unslice 402 may distribute the vertex shading tasks uniformly across all of the available slices for vertex shading operations. In other words, in order to make vertex distribution dynamic across an unslice connected to two slices or an unslice connected to four slices, the unslice may simply divide the number of vertex shading tasks by the number of slices and distribute the total number of vertex shading tasks divided by the number of slices to each slice. The unslice 402 may have a run-time programmable parameter, or configuration register, which may be used to calculate this distribution. In some aspects, the unslice 402 may blindly forward each vertex primitive to each slice in a round-robin way.

When the unslice 402 distributes pixel shading tasks to the connected slices, the unslice 402 may use a position-mapped hashing function for fragment-distribution specific to the number of slices. For example, to enable runtime decision of pixel redistribution, the hardware of the unslice 402 may have all four flavors of hashing functions built into it, as opposed to having a single hashing function, and may select the hashing function at runtime to distribute the pixel shading tasks to the connected slices.

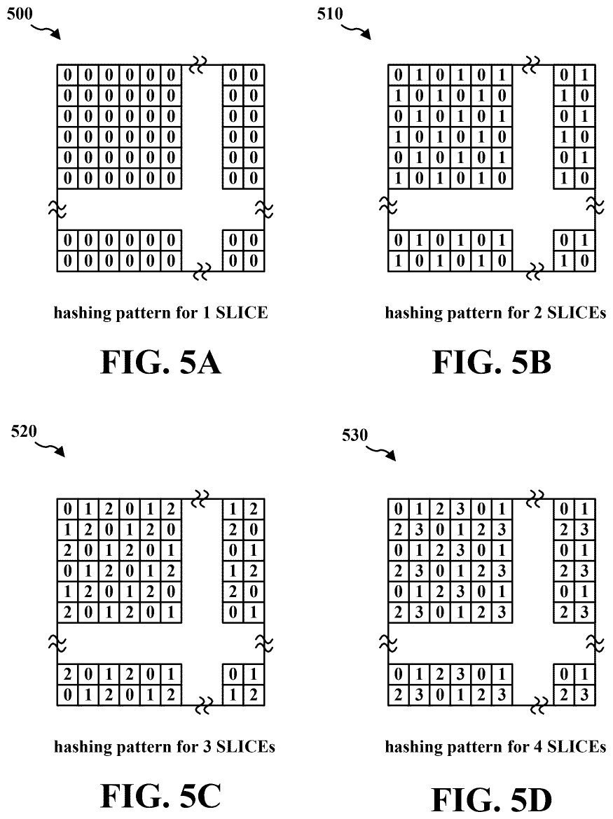

FIGS. 5A-5D illustrate exemplary hashtag patterns for scalable GPUs having various numbers of slices. FIG. 5A is a diagram 500 of a hashtag pattern for one slice. FIG. 5B is a diagram 510 of a hashtag pattern for two slices. FIG. 5C is a diagram 520 of a hashtag pattern for three slices. FIG. 5D is a diagram 530 of a hashtag pattern for four slices. While four hashtag patterns are shown in FIGS. 5A-5D, a scalable GPU may have any number of hashtag patterns to support any number of slices in other aspects. Each hashing pattern may represent a set of grid elements that may be distributed to a set of slices based on the hashing pattern. For example, where an unslice is connected to two slices, the first slice may be assigned an identifier of slice 0 while the second slice may be assigned an identifier of slice 1. The hashing pattern shown in FIG. 5B may be used to distribute the pixel shading tasks. In another example, where an unslice is connected to four slices, the first slice may be assigned an identifier of slice 0, the second slice may be assigned an identifier of slice 1, the third slice may be assigned an identifier of slice 2, and the fourth slice may be assigned an identifier of slice 3. The hashing pattern shown in FIG. 5D may be used to distribute the pixel shading tasks. In some aspects, the hashtag patterns, or functions, may be built into the hardware of a graphics processor.

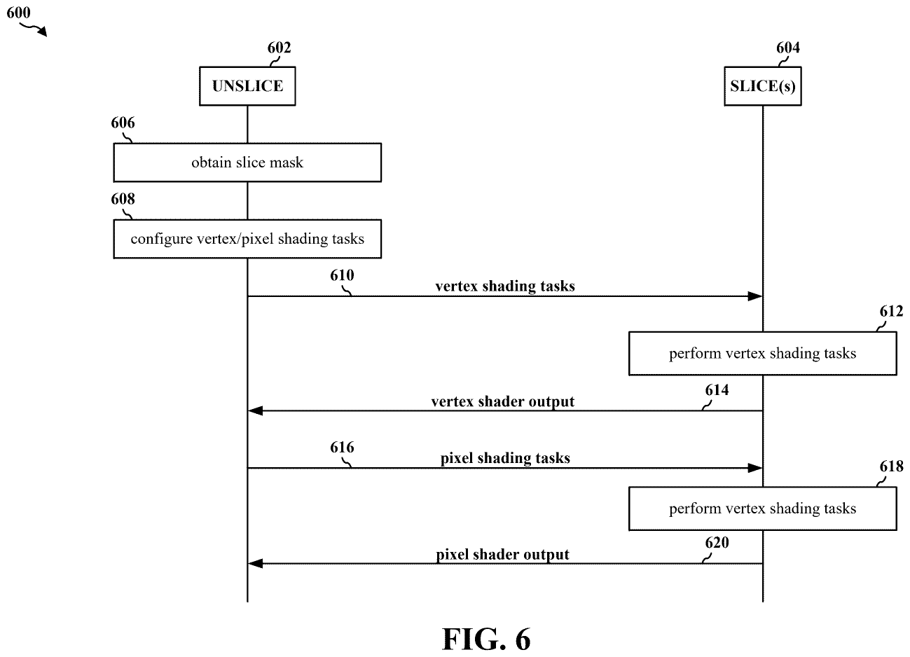

FIG. 6 is a call flow diagram 600 illustrating example communications between an unslice 602 of a GPU and a set of slices 604 of the GPU. At 606, the unslice 602 may obtain a slice mask, for example from a register of the unslice 602. In some aspects, a user may program the register of the unslice 602. For example, with an unslice that may be connected to a maximum for 4 slices, a 4-bit mask may be used, where each bit represents a slice located in a location about the unslice 602. In some aspects, during a boot process of the GPU, the unslice 602 may obtain the slice mask by automatically detecting how many slices are not tied off. For example, when tying off a port, the port may be connected to a power source, or to a ground. In some aspects, the unslice 602 may determine the number of active slices by analyzing the obtained slice mask (e.g., by counting the number of set bits in a 4-bit mask). In some aspects, the unslice 602 may determine the number of active slices by reading a separate register dedicated to storing the number of active slices for the GPU. A user may program such a register, or such a register may be loaded during a boot process of the GPU by a slice configuration engine that determines the number of active slices based on a slice mask.

At 608, the unslice 602 may configure a set of vertex shading tasks and a set of pixel shading tasks for the set of slices 604. The unslice 602 may configure the set of vertex shading tasks to be evenly distributed as uniformly as possible to the set of slices 604 based on the obtained number of active slices. The unslice 602 may configure the set of pixel shading tasks to be distributed based on a hashing function, such as those shown in FIGS. 5A-5D. The unslice 602 may retrieve the hashing function based on the slice mask obtained at 606.

The unslice 602 may output an indicator 610 of the set of vertex shading tasks to the set of slices 604. The set of slices may obtain the indicator 610 of the set of vertex shading tasks from the unslice 602. While the call flow diagram 600 illustrates an indicator 610, each of the set of slices 604 may obtain a separate indicator, indicating the set of vertex shading tasks that are distributed to that particular slice. At 612, the set of slices 604 may perform the vertex shading tasks indicated by the indicator 610. The set of slices 604 may output an indicator 614 of the completion of the vertex shading tasks to the unslice 602.

The unslice 602 may output an indicator 616 of the set of pixel shading tasks to the set of slices 604. The set of slices may obtain the indicator 616 of the set of pixel shading tasks from the unslice 602. While the call flow diagram 600 illustrates an indicator 616, each of the set of slices 604 may obtain a separate indicator, indicating the set of pixel shading tasks that are distributed to that particular slice. The unslice 602 may output the indicator 616 of the set of pixel shading tasks based on a hashing function selected based on the slice mask. At 618, the set of slices 604 may perform the pixel shading tasks indicated by the indicator 616. The set of slices 604 may output an indicator 620 of the completion of the pixel shading tasks to the unslice 602.

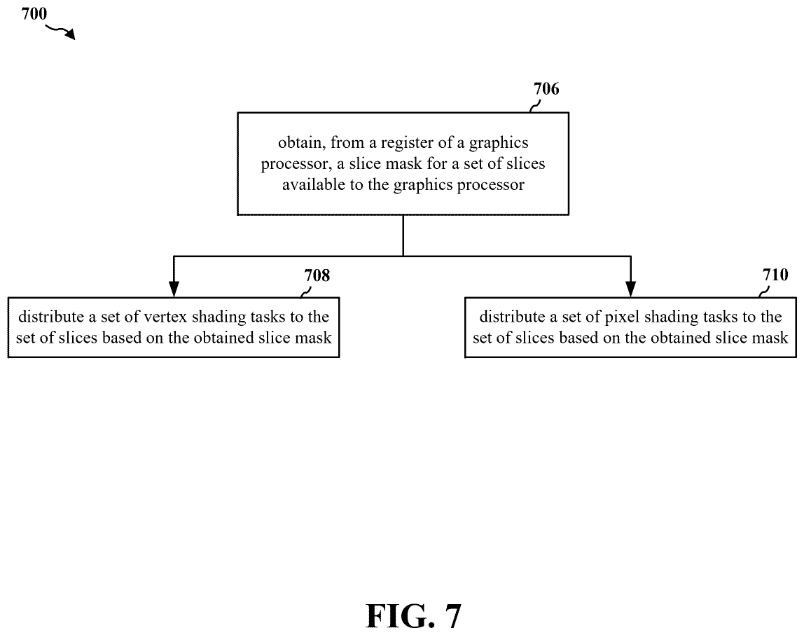

FIG. 7 is a flowchart 700 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-3, 4A-4B, 5A-5D, and 6.

At 706, the apparatus may obtain, from a register of a graphics processor, a slice mask for a set of slices available to the graphics processor. For example, referring to FIG. 6, the unslice 602 may perform 706 by obtaining, from a register of the unslice 602, a slice mask for the set of slices 604 available to the unslice 602. Moreover, 706 may be performed by the slice configuration engine 198 in FIG. 1.

At 708, the apparatus may distribute a set of vertex shading tasks to the set of slices based on the obtained slice mask. For example, referring to FIG. 6, the unslice 602 may perform 708 by distributing a set of vertex shading tasks to the set of slices as the indicator 610 of the vertex shading tasks based on a number of available slices. The number of available slices may be derived from the slice mask or may be read from a register of the unslice 602. Moreover, 708 may be performed by the slice configuration engine 198 in FIG. 1.

At 710, the apparatus may distribute a set of pixel shading tasks to the set of slices based on the obtained slice mask. For example, referring to FIG. 6, the unslice 602 may perform 710 by distributing a set of pixel shading tasks to the set of slices as the indicator 616 of the pixel shading tasks based on the slice mask. Moreover, 710 may be performed by the slice configuration engine 198 in FIG. 1.

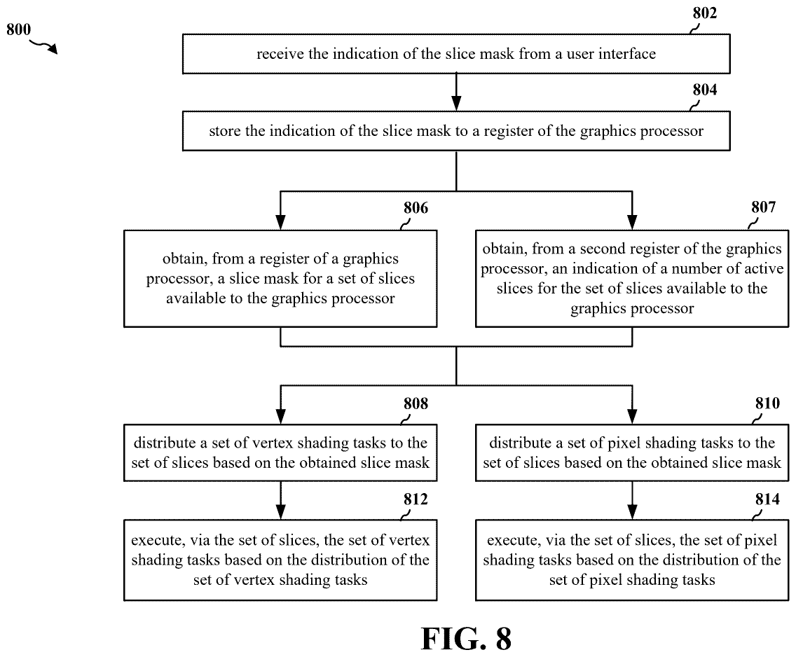

FIG. 8 is a flowchart 800 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-3, 4A-4B, 5A-5D, and 6.

At 802, the apparatus may receive the indication of the slice mask from a user interface. For example, referring to FIG. 6, the unslice 602 may perform 802 by receiving an indication of the slice mask from a user interface. In other words, a user may input the slice mask manually. Moreover, 802 may be performed by the slice configuration engine 198 in FIG. 1. In some aspects, the slice mask may be stored in a memory of the apparatus during the manufacturing stage of a chop GPU.

At 804, the apparatus may store the indication of the slice mask to a register of the graphics processor. For example, referring to FIG. 6, the unslice 602 may perform 804 by storing an indication of the obtained slice mask to a register of the graphics processor. Moreover, 804 may be performed by the slice configuration engine 198 in FIG. 1.

At 806, the apparatus may obtain, from a register of a graphics processor, a slice mask for a set of slices available to the graphics processor. For example, referring to FIG. 6, the unslice 602 may perform 806 by obtaining, from a register of the unslice 602, a slice mask for the set of slices 604 available to the unslice 602. Moreover, 806 may be performed by the slice configuration engine 198 in FIG. 1.

At 807, the apparatus may obtain, from a second register of the graphics processor, an indication of a number of active slices of the set of slices available to the graphics processor. For example, referring to FIG. 6, the unslice 602 may perform 807 by obtaining, from a second register of the unslice 602, an indication of a number of active slices of the set of slices available to the unslice 602. Moreover, 807 may be performed by the slice configuration engine 198 in FIG. 1.

At 808, the apparatus may distribute a set of vertex shading tasks to the set of slices based on the obtained slice mask. For example, referring to FIG. 6, the unslice 602 may perform 808 by distributing a set of vertex shading tasks to the set of slices as the indicator 610 of the vertex shading tasks based on a number of available slices. The number of available slices may be derived from the slice mask or may be read from a register of the unslice 602. Moreover, 808 may be performed by the slice configuration engine 198 in FIG. 1.

At 810, the apparatus may distribute a set of pixel shading tasks to the set of slices based on the obtained slice mask. For example, referring to FIG. 6, the unslice 602 may perform 810 by distributing a set of pixel shading tasks to the set of slices as the indicator 616 of the pixel shading tasks based on the slice mask. Moreover, 810 may be performed by the slice configuration engine 198 in FIG. 1.

At 812, the apparatus may execute, via the set of slices, the set of vertex shading tasks based on the distribution of the set of vertex shading tasks. For example, referring to FIG. 6, the unslice 602 may perform 812 by executing, via the set of slices 604, the set of vertex shading tasks based on the distribution of the set of vertex shading tasks by the unslice 602. Moreover, 812 may be performed by the slice configuration engine 198 in FIG. 1.

At 814, the apparatus may execute, via the set of slices, the set of pixel shading tasks based on the distribution of the set of pixel shading tasks. For example, referring to FIG. 6, the unslice 602 may perform 814 by executing, via the set of slices 604, the set of pixel shading tasks based on the distribution of the set of pixel shading tasks by the unslice 602. Moreover, 814 may be performed by the slice configuration engine 198 in FIG. 1.

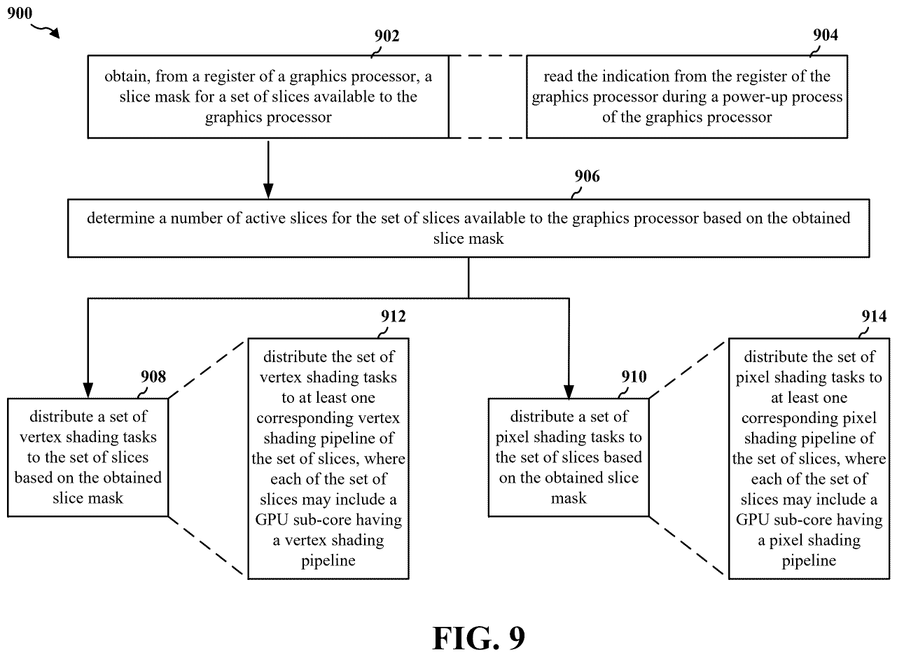

FIG. 9 is a flowchart 900 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-3, 4A-4B, 5A-5D, and 6.

At 902, the apparatus may obtain, from a register of a graphics processor, a slice mask for a set of slices available to the graphics processor. For example, referring to FIG. 6, the unslice 602 may perform 902 by obtaining, from a register of the unslice 602, a slice mask for the set of slices 604 available to the unslice 602. Moreover, 902 may be performed by the slice configuration engine 198 in FIG. 1.

At 904, the apparatus may obtain, from a register of a graphics processor, a slice mask for a set of slices available to the graphics processor by reading the indication from the register of the graphics processor during a power-up process of the graphics processor. For example, referring to FIG. 6, the unslice 602 may perform 904 by reading the indication from the register of the unslice 602 during a power-up process of the GPU. Moreover, 904 may be performed by the slice configuration engine 198 in FIG. 1.

At 906, the apparatus may obtain, from a register of a graphics processor, a slice mask for a set of slices available to the graphics processor. For example, referring to FIG. 6, the unslice 602 may perform 906 by obtaining, from a register of the unslice 602, a slice mask for the set of slices 604 available to the unslice 602. Moreover, 906 may be performed by the slice configuration engine 198 in FIG. 1.

At 908, the apparatus may distribute a set of vertex shading tasks to the set of slices based on the obtained slice mask. For example, referring to FIG. 6, the unslice 602 may perform 908 by distributing a set of vertex shading tasks to the set of slices as the indicator 610 of the vertex shading tasks based on a number of available slices. The number of available slices may be derived from the slice mask or may be read from a register of the unslice 602. Moreover, 908 may be performed by the slice configuration engine 198 in FIG. 1.

At 910, the apparatus may distribute a set of pixel shading tasks to the set of slices based on the obtained slice mask. For example, referring to FIG. 6, the unslice 602 may perform 910 by distributing a set of pixel shading tasks to the set of slices as the indicator 616 of the pixel shading tasks based on the slice mask. Moreover, 910 may be performed by the slice configuration engine 198 in FIG. 1.

At 912, the apparatus may distribute a set of vertex shading tasks to the set of slices based on the obtained slice mask by distributing the set of vertex shading tasks to at least one corresponding vertex shading pipeline of the set of slices, where each of the set of slices may include a GPU sub-core having a vertex shading pipeline. For example, referring to FIG. 6, the unslice 602 may perform 912 by distributing the set of vertex shading tasks to at least one corresponding vertex shading pipeline of the set of slices 604, where each of the set of slices may include a GPU sub-core having a vertex shading pipeline. In some aspects, the apparatus may determine a corresponding vertex shading pipeline based on a round-robin scheme. Moreover, 912 may be performed by the slice configuration engine 198 in FIG. 1.

At 914, the apparatus may distribute a set of pixel shading tasks to the set of slices based on the obtained slice mask by distributing the set of pixel shading tasks to at least one corresponding pixel shading pipeline of the set of slices, where each of the set of slices may include a GPU sub-core having a pixel shading pipeline. For example, referring to FIG. 6, the unslice 602 may perform 914 by distributing the set of pixel shading tasks to at least one corresponding pixel shading pipeline of the set of slices 604, where each of the set of slices may include a GPU sub-core having a pixel shading pipeline. In some aspects, the apparatus may determine a corresponding vertex shading pipeline based on a hashtag pattern or a hashtag function. Moreover, 914 may be performed by the slice configuration engine 198 in FIG. 1.

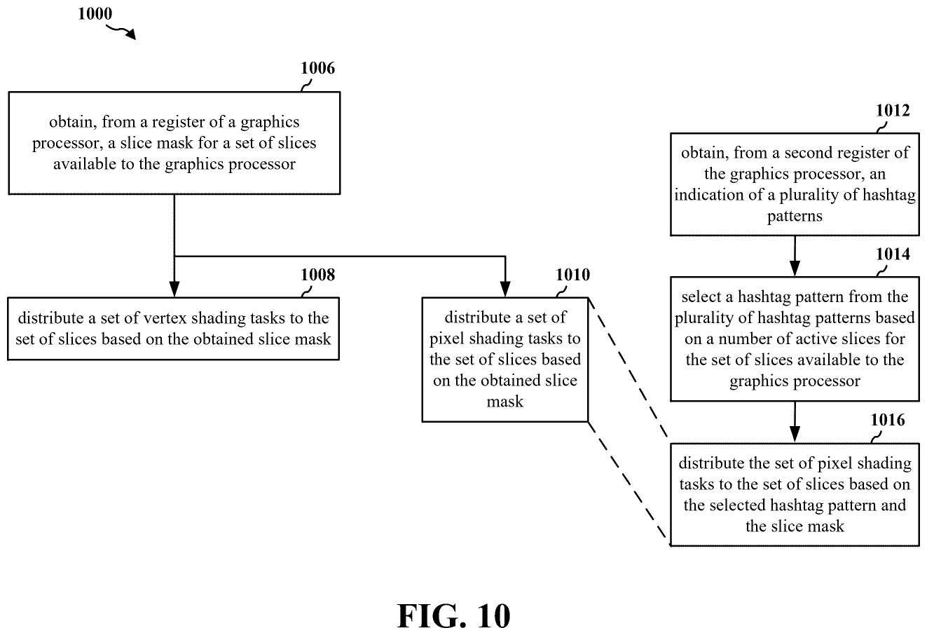

FIG. 10 is a flowchart 1000 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-3, 4A-4B, 5A-5D, and 6.

At 1006, the apparatus may obtain, from a register of a graphics processor, a slice mask for a set of slices available to the graphics processor. For example, referring to FIG. 6, the unslice 602 may perform 1006 by obtaining, from a register of the unslice 602, a slice mask for the set of slices 604 available to the unslice 602. Moreover, 1006 may be performed by the slice configuration engine 198 in FIG. 1.

At 1008, the apparatus may distribute a set of vertex shading tasks to the set of slices based on the obtained slice mask. For example, referring to FIG. 6, the unslice 602 may perform 1008 by distributing a set of vertex shading tasks to the set of slices as the indicator 610 of the vertex shading tasks based on a number of available slices. The number of available slices may be derived from the slice mask or may be read from a register of the unslice 602. Moreover, 1008 may be performed by the slice configuration engine 198 in FIG. 1.

At 1010, the apparatus may distribute a set of pixel shading tasks to the set of slices based on the obtained slice mask. For example, referring to FIG. 6, the unslice 602 may perform 1010 by distributing a set of pixel shading tasks to the set of slices as the indicator 616 of the pixel shading tasks based on the slice mask. Moreover, 1010 may be performed by the slice configuration engine 198 in FIG. 1.

At 1012, the apparatus may obtain, from a second register of the graphics processor, an indication of a plurality of hashtag patterns. For example, referring to FIG. 6, the unslice 602 may perform 1012 by obtaining, from a second register of the unslice 602 an indication of a plurality of hashtag patterns. Moreover, 1012 may be performed by the slice configuration engine 198 in FIG. 1.

At 1014, the apparatus may select a hashtag pattern from the plurality of hashtag patterns based on a number of active slices of the set of slices available to the graphics processor. For example, referring to FIG. 6, the unslice 602 may perform 1014 by selecting a hashtag pattern from the plurality of hashtag patterns based on a number of active slices of the set of slices available to the unslice 602. Moreover, 1014 may be performed by the slice configuration engine 198 in FIG. 1.

At 1016, the apparatus may distribute a set of pixel shading tasks to the set of slices based on the obtained slice mask by distributing the set of pixel shading tasks to the set of slices based on the selected hashtag pattern and the slice mask. For example, referring to FIG. 6, the unslice 602 may perform 1016 by distributing the set of pixel shading tasks to the set of slices 604 based on the selected hashtag pattern and the slice mask. Moreover, 1016 may be performed by the slice configuration engine 198 in FIG. 1.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for obtaining, from a register of a graphics processor, a slice mask for a set of slices available to the graphics processor. The apparatus may further include means for distributing a set of vertex shading tasks to the set of slices based on the obtained slice mask. The apparatus may further include means for distributing a set of pixel shading tasks to the set of slices based on the obtained slice mask. The means may include the slice configuration engine 198 of FIG. 1.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of graphics processing, comprising: obtaining, from a register of a graphics processor, a slice mask for a set of slices available to the graphics processor; distributing a set of vertex shading tasks to the set of slices based on the obtained slice mask; and distributing a set of pixel shading tasks to the set of slices based on the obtained slice mask.

Aspect 2 is the method of aspect 1, further comprising: executing, via the set of slices, the set of vertex shading tasks based on the distribution of the set of vertex shading tasks; and executing, via the set of slices, the set of pixel shading tasks based on the distribution of the set of pixel shading tasks.

Aspect 3 is the method of either of aspects 1 or 2, wherein each of the set of slices comprises a graphics processor unit (GPU) slice core having a vertex shading pipeline and a pixel shading pipeline, wherein distributing the set of vertex shading tasks to the set of slices based on the obtained slice mask comprises: distributing the set of vertex shading tasks to at least one corresponding vertex shading pipeline of the set of slices, wherein distributing the set of pixel shading tasks to the set of slices based on the obtained slice mask comprises: distributing the set of pixel shading tasks to at least one corresponding pixel shading pipeline of the set of slices.

Aspect 4 is the method of any of aspects 1 to 3, further comprising: determining a number of active slices of the set of slices based on the obtained slice mask.

Aspect 5 is the method of any of aspects 1 to 4, further comprising: obtaining, from a second register of the graphics processor, an indication of a number of active slices of the set of slices available to the graphics processor.

Aspect 6 is the method of any of aspects 1 to 5, wherein distributing the set of pixel shading tasks to the set of slices based on the obtained slice mask comprises: selecting a hashtag pattern from a plurality of hashtag patterns based on a number of active slices of the set of slices available to the graphics processor; and distributing the set of pixel shading tasks to the set of slices based on the selected hashtag pattern and the slice mask.

Aspect 7 is the method of aspect 6, further comprising: obtaining, from a second register of the graphics processor, an indication of the plurality of hashtag patterns before the selection of the hashtag pattern from the plurality of hashtag patterns.

Aspect 8 is the method of any of aspects 1 to 7, wherein obtaining, from the register of the graphics processor, the indication of the slice mask for the set of slices available to the graphics processor comprises: reading the indication from the register of the graphics processor during a power-up process of the graphics processor.

Aspect 9 is the method of any of aspects 1 to 8, further comprising: receiving the indication of the slice mask from a user interface; and storing the indication of the slice mask to the register of the graphics processor before obtaining, from the register of the graphics processor, the indication of the slice mask.

Aspect 10 is an apparatus for graphics processing including at least one processor coupled to a memory and configured to implement a method as in any of aspects 1-9.

Aspect 11 may be combined with aspect 10 and includes that the apparatus is a wireless communication device.

Aspect 12 is an apparatus for graphics processing including means for implementing a method as in any of aspects 1-9.

Aspect 13 is a computer-readable medium (e.g., a non-transitory computer-readable medium) storing computer executable code, the code when executed by at least one processor causes the at least one processor to implement a method as in any of aspects 1-9.

Various aspects have been described herein. These and other aspects are within the scope of the following claims.

What is claimed is:

1. An apparatus for graphics processing, comprising:
a memory; and
a processor coupled to the memory and, based at least in part on information stored in the memory, the processor is configured to:
obtain, from a register of a graphics processor, a slice mask for a set of slices available to the graphics processor;
distribute a set of vertex shading tasks to the set of slices based on the obtained slice mask; and
distribute a set of pixel shading tasks to the set of slices based on the obtained slice mask.

2. The apparatus of claim 1, wherein the processor is further configured to:
execute, via the set of slices, the set of vertex shading tasks based on the distribution of the set of vertex shading tasks; and
execute, via the set of slices, the set of pixel shading tasks based on the distribution of the set of pixel shading tasks.

3. The apparatus of claim 1, wherein each of the set of slices comprises a graphics processor unit (GPU) slice core having a vertex shading pipeline and a pixel shading pipeline, wherein, to distribute the set of vertex shading tasks to the set of slices based on the obtained slice mask, the processor is configured to:
distribute the set of vertex shading tasks to at least one corresponding vertex shading pipeline of the set of slices, wherein, to distribute the set of pixel shading tasks to the set of slices based on the obtained slice mask, the processor is configured to:
distribute the set of pixel shading tasks to at least one corresponding pixel shading pipeline of the set of slices.

4. The apparatus of claim 1, wherein the processor is further configured to:
determine a number of active slices of the set of slices based on the obtained slice mask.

5. The apparatus of claim 1, wherein the processor is further configured to:
obtain, from a second register of the graphics processor, an indication of a number of active slices of the set of slices available to the graphics processor.

6. The apparatus of claim 1, wherein, to distribute the set of pixel shading tasks to the set of slices based on the obtained slice mask, the processor is configured to:
select a hashtag pattern from a plurality of hashtag patterns based on a number of active slices of the set of slices available to the graphics processor; and
distribute the set of pixel shading tasks to the set of slices based on the selected hashtag pattern and the slice mask.

7. The apparatus of claim 6, wherein the processor is further configured to:
obtain, from a second register of the graphics processor, an indication of the plurality of hashtag patterns before the selection of the hashtag pattern from the plurality of hashtag patterns.

8. The apparatus of claim 1, wherein, to obtain, from the register of the graphics processor, the slice mask for the set of slices available to the graphics processor, the processor is configured to:
read the slice mask from the register of the graphics processor during a power-up process of the graphics processor.

9. The apparatus of claim 1, wherein the processor is further configured to:
receive the slice mask from a user interface; and
store the slice mask to the register of the graphics processor before obtaining, from the register of the graphics processor, the slice mask.

10. The apparatus of claim 1, wherein the apparatus comprises a wireless communication device.

11. A method of graphics processing, comprising:
obtaining, from a register of a graphics processor, a slice mask for a set of slices available to the graphics processor;
distributing a set of vertex shading tasks to the set of slices based on the obtained slice mask; and
distributing a set of pixel shading tasks to the set of slices based on the obtained slice mask.

12. The method of claim 11, further comprising:
executing, via the set of slices, the set of vertex shading tasks based on the distribution of the set of vertex shading tasks; and
executing, via the set of slices, the set of pixel shading tasks based on the distribution of the set of pixel shading tasks.

13. The method of claim 11, wherein each of the set of slices comprises a graphics processor unit (GPU) slice core having a vertex shading pipeline and a pixel shading pipeline, wherein distributing the set of vertex shading tasks to the set of slices based on the obtained slice mask comprises:
distributing the set of vertex shading tasks to at least one corresponding vertex shading pipeline of the set of slices, wherein distributing the set of pixel shading tasks to the set of slices based on the obtained slice mask comprises:
distributing the set of pixel shading tasks to at least one corresponding pixel shading pipeline of the set of slices.

14. The method of claim 11, further comprising:
determining a number of active slices of the set of slices based on the obtained slice mask.

15. The method of claim 11, further comprising:
obtaining, from a second register of the graphics processor, an indication of a number of active slices of the set of slices available to the graphics processor.

16. The method of claim 11, wherein distributing the set of pixel shading tasks to the set of slices based on the obtained slice mask comprises:
selecting a hashtag pattern from a plurality of hashtag patterns based on a number of active slices of the set of slices available to the graphics processor; and
distributing the set of pixel shading tasks to the set of slices based on the selected hashtag pattern and the slice mask.

17. The method of claim 16, further comprising:
obtaining, from a second register of the graphics processor, an indication of the plurality of hashtag patterns before the selection of the hashtag pattern from the plurality of hashtag patterns.

18. The method of claim 11, wherein obtaining, from the register of the graphics processor, the slice mask for the set of slices available to the graphics processor comprises:
reading the slice mask from the register of the graphics processor during a power-up process of the graphics processor.

19. The method of claim 11, further comprising:
receiving the slice mask from a user interface; and
storing the slice mask to the register of the graphics processor before obtaining, from the register of the graphics processor, the slice mask.

20. A computer-readable medium storing computer executable code, the code when executed by a processor, causes the processor to:
obtain, from a register of a graphics processor, a slice mask for a set of slices available to the graphics processor;
distribute a set of vertex shading tasks to the set of slices based on the obtained slice mask; and
distribute a set of pixel shading tasks to the set of slices based on the obtained slice mask.
